(19) United States
(12) Patent Application Publication
(10) Pub. No.: US 2020/0339404 A1
(43) Pub. Date: Oct. 29, 2020

(54) MIXING VALVE, RETRO-FITTING METHOD OF A DISPENSING DEVICE FOR DISPENSING A COOLED BEVERAGE MIXED WITH A GAS, AND METHOD FOR DISPENSING A BEVERAGE MIXED WITH SAID GAS

(71) Applicant: BCOOL SRL, Casale Monferrato (AL) (IT)

(72) Inventors: Marco CAROTI, Casale Monferrato (AL) (IT); Marcello BUZZONI, Casale Monferrato (AL) (IT)

(21) Appl. No.: 16/958,943

(22) PCT Filed: Dec. 28, 2018
(86) PCT No.: PCT/IB2018/060705

§ 371 Date: Jun. 29, 2020

(30) Foreign Application Priority Data
Dec. 29, 2017 (EP) 17211171.8

(51) Int. Cl. B67D 1/00; B67D 1/08; B67D 1/12

(52) U.S. Cl. CPC B67D 1/0052; B67D 1/1279; B67D 1/0857

(57) ABSTRACT

A mixing valve is described for a dispensing device for dispensing a cooled beverage mixed with a gas, comprising: a first inlet which can be fluidically connected to a first source of gas and can be supplied with the gas; a second inlet which can be connected to a second source of the beverage without gas and can be supplied with the beverage not mixed with the gas; an outlet which can be connected to a first dispensing mouth for dispensing the beverage mixed with the gas; the dispensing mouth is available in a closed or open configuration to prevent or allow dispensing of the beverage mixed with said gas; a chamber interposed between the first and the second inlet on one side and the outlet on the other side and adapted to allow mixing of the gas and non-mixed beverage, thus forming the beverage mixed with the gas; and regulation means, configured to allow, when the first dispensing mouth is arranged in the open configuration, the passage, respectively, of a first flow value of gas between the first inlet and the outlet and a second flow value of non-mixed beverage between the second inlet and the outlet.

### CROSS-REFERENCE TO RELATED APPLICATIONS

This patent application claims priority from European patent application no. 17211171.8 filed on 29 Dec. 2017, the entire disclosure of which is incorporated herein by reference.

### TECHNICAL FIELD

The present invention concerns a mixing valve for a dispensing device for dispensing a cooled beverage mixed with a gas, in particular nitrogen or a mixture containing nitrogen or compressed air.

The present invention also concerns a retro-fitting method of a dispensing device for dispensing a beverage mixed with said gas.

Lastly, the present invention concerns a dispensing method for dispensing a beverage mixed with said gas.

### BACKGROUND ART

The U.S. Pat. Nos. 6,138,995 and 8,438,969 teach how to charge carbonated drinks, such as beer or soda, with nitrogen. By the term “charge” we mean the formation of a physically indistinguishable uniform mixture without chemical interactions between the nitrogen or air and the drink. In particular, the nitrogen results in a drink with a thicker mouthfeel and reduces the acidity of the drink.

A cold beverage formed of coffee mixed with a gaseous mixture containing nitrogen or compressed air is also known as “Nitro cold brew coffee” abbreviated to “NCB”.

When said beverage is dispensed at atmospheric pressure, the gas slowly separates from the beverage, generating a creamy froth with cascade effect similar to that of stout beer.

WO-A-2015/175244 describes a dispensing device for dispensing a cold non-carbonated beverage, in particular tea or coffee, mixed with nitrogen or with a mixture of nitrogen and carbon dioxide.

In further detail, the dispensing device comprises:
a container for the beverage, for example a pressurizable keg or a non-pressurizable bag-in-box;
a beverage cooling circuit;
a source of a pressurized gas, for example nitrogen or a mixture containing nitrogen like air;
a liquid/gas mixer, which is fluidically connected to the beverage container and to the gas source and is adapted to allow charging of the gas containing nitrogen into the beverage; and
a dispenser of the mixed beverage, which is fluidically connected to the mixer.

In particular, the liquid/gas mixer is of the permeable membrane type, i.e. of the type containing hollow fibres. Said permeable membrane comprises a plurality of passages which are, in use, crossed by the gas containing nitrogen and allow said mixture to mix with the beverage.

Due to said configuration, in the above-mentioned solution the beverage is charged both when the dispenser is operated and when the dispenser is not operated.

Consequently, in the condition known as casual drink, i.e. when the dispenser is operated after a long period of inactivity, the gas contained in the volume between the membrane exchanger and the dispenser itself could partially or completely separate from the beverage, locating itself above the beverage.

It follows that, in the case of a casual drink, the beginning of the dispensing is not uniform as in the previous dispensing operations in terms of quality and scenic effect of cascade and creamy froth.

Furthermore, the appearance of the beverage dispensed meets expectations and is constant over time only after a certain number of dispensing operations.

The need is felt in the sector to ensure that the desired scenic effect is achieved and/or in particular in casual drink conditions.

The need is also felt in the sector to ensure an effect which is as scenic and as constant as possible.

The need to be able to selectively adjust the quantity of gas mixed in the cooled beverage is also felt in the sector, in order to be able to selectively adjust the height of the creamy froth and the scenic effect of the beverage dispensed mixed with gas and the height of the froth/cream that forms during the dispensing operation.

Lastly, the need is felt in the sector to reduce the number of components of the dispenser, as far as possible.

### DISCLOSURE OF INVENTION

The aim of the present invention is to provide an in-line mixing valve for a dispensing device for dispensing a cooled beverage mixed with a gas, in particular nitrogen or a mixture containing nitrogen or air, which meets in a simple inexpensive manner at least one of the above-mentioned needs.

The above-mentioned object is achieved by the present invention, since it concerns an in-line mixing valve for a dispensing device for dispensing a cooled beverage mixed with a gas, as defined in claim 1.

The present invention also concerns a retro-fitting method of a dispensing device for dispensing a cooled beverage mixed with a gas, in particular nitrogen or a mixture containing nitrogen or compressed air, as defined in claim 12.

Lastly, the present invention concerns a dispensing method for dispensing a beverage mixed with a gas, as defined in claim 14.

### BRIEF DESCRIPTION OF THE DRAWINGS

For a better understanding of the present invention, four embodiments are described below, purely by way of non-limiting example and with reference to the accompanying drawings, in which:

FIG. 1 is a functional diagram of a first embodiment of a dispenser device comprising a mixing valve produced according to the teachings of the present invention;

FIG. 2 is a functional diagram of a second embodiment of the dispenser device of FIG. 1;

FIG. 3 is a functional diagram of a third embodiment of the dispenser device of FIG. 1;

FIG. 4 is a functional diagram of a fourth embodiment of the dispenser device of FIG. 1;

FIG. 5 is a functional diagram on an enlarged scale of the mixing valve according to the present invention;

FIGS. 6 and 7 are perspective views according to respective different visual angles of the mixing valve of FIG. 5;

FIG. 8 is an overhead view of the mixing valve of FIGS. 5 to 7;

FIGS. 9 and 10 are respective sections of the mixing valve of FIGS. 1 to 6, along the lines IX-IX; X-X.

### BEST MODE FOR CARRYING OUT THE INVENTION

With reference to the attached figures, the number 1 indicates a dispensing device for dispensing a cooled beverage mixed with a gas, comprising a valve 2 according to the invention.

By the term “gas” in the present description we mean a mixture containing nitrogen. In particular, the gas is nitrogen, air or a mixture of nitrogen and carbon dioxide.

By the expression “cooled beverage” in the present description we mean a beverage dispensed at a temperature below ambient temperature, for example between 2 and 8 degrees centigrade.

By the expression “beverage mixed with the gas” in the present description we mean a beverage which forms a physically uniform mixture with the gas, without chemical interaction between beverage and gas. Said gas improves the scenic appearance of the beverage mixed with the gas.

By the term “beverage not mixed with the gas” in the present description we mean a beverage which does not form any mixture with the gas.

Preferably, the beverage is coffee, non-carbonated. Even more preferably, the beverage is cold-extracted coffee.

Alternatively, the beverage could be tea, fruit juice, milk or an electrolyte drink.

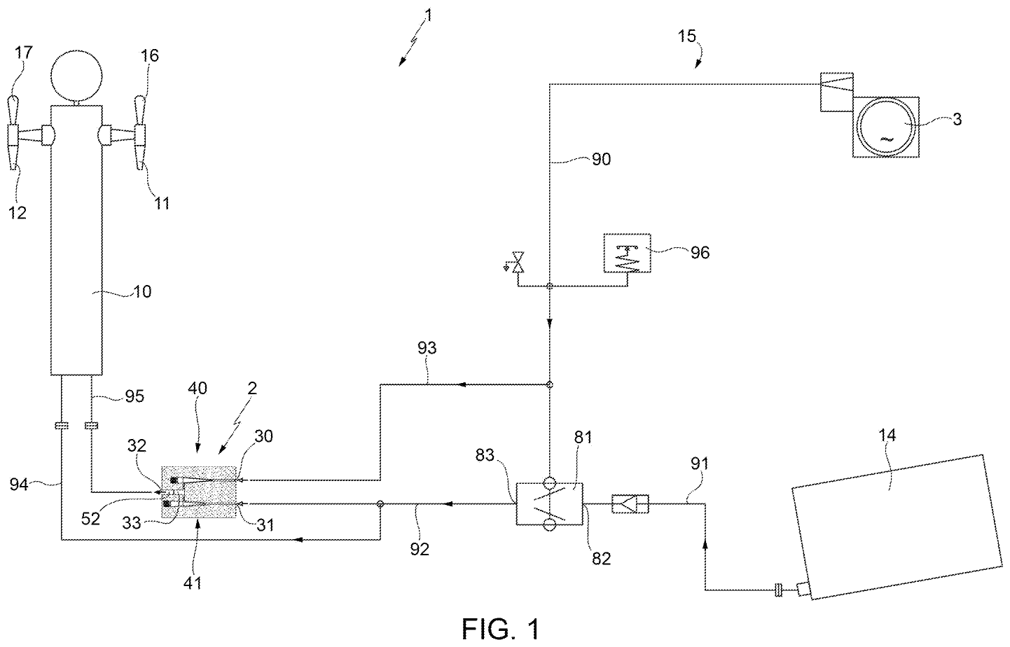

With reference to FIG. 1, the device 1 comprises essentially:
a dispenser 10 comprising, in turn, a dispensing mouth 11 and a dispensing mouth 12;
a source 3 of the mixture containing nitrogen at a certain pressure, a compressor in the case illustrated; and
a source 14 filled with the beverage not mixed with the gas.

In the case illustrated, the compressor is a medical type compressor that does not require lubrication oil for operation.

The device 1 also comprises a fluidic circuit 15, which fluidically connects the sources 13, 14 with the mouths 11, 12 respectively so as to alternatively allow:
dispensing or non-dispensing of the beverage mixed with gas through the mouth 11; or
dispensing or non-dispensing of the non-mixed beverage through the mouth 12.

The fluidic circuit 15 is illustrated in greater detail in the following part of the present description.

More specifically, the device 1 comprises a pair of dispensing levers 16, 17 which can be manually moved between:
respective open configurations which respectively allow dispensing of the beverage mixed with the gas and the non-mixed beverage through the respective mouths 11, 12; and
respective closed configurations which respectively prevent dispensing of the beverage mixed with the gas and the non-mixed beverage through the respective mouths 11, 12.

Advantageously, the device 1 comprises a valve 2 in turn comprising:
an inlet 30 fluidically connected with the source 13 and supplied with the gas or air under pressure;
an inlet 31 fluidically connected with the source 14 and supplied with the beverage without gas or air under pressure; and
an outlet 32 fluidically connected with the mouth 11;
a mixing chamber 33, which is interposed between the inlets 30, 31 on one side and the outlet 32 on the other side, and is configured to allow the mixing of said gas and beverage not mixed with the gas, thus forming the beverage mixed with gas; and
a pair of regulators 40, 41 which, when the lever 16 is arranged in the open configuration and consequently the pressure at the outlet 32 drops below the pressure at the inlets 30, 31, are configured to allow the passage of:

a first flow value of the gas between the inlet 30 and the outlet 32; and

a second flow value of the beverage not mixed with the gas between the inlet 31 and the outlet 32.

It is important to underline that the first and the second flow value determine the quality of the beverage mixed with gas and the height of the froth produced when the beverage is dispensed.

It is furthermore important to underline that mixing of the gas and the beverage not mixed with the gas and consequent formation of the beverage mixed with gas occurs substantially only when the lever 16 is moved to the open configuration and the pressure at the outlet 32 is below the pressure of the inlets 30, 31.

Otherwise, when the lever 16 is in the closed configuration, there is no substantial difference in pressure between the inlets 30, 31 and the outlet 32 and, consequently, there is no substantial passage of flow either of gas or non-mixed beverage.

In the case illustrated, the gas and the beverage not mixed with gas are supplied from the fluidic circuit 15 to the inlets 30, 31 at a first and a second pressure value identical to each other.

The pressure value of the beverage mixed at the outlet 32 is equal to the value of the atmospheric pressure, i.e. to a value lower than said first and second value, when the mouth 11 is arranged in the open configuration.

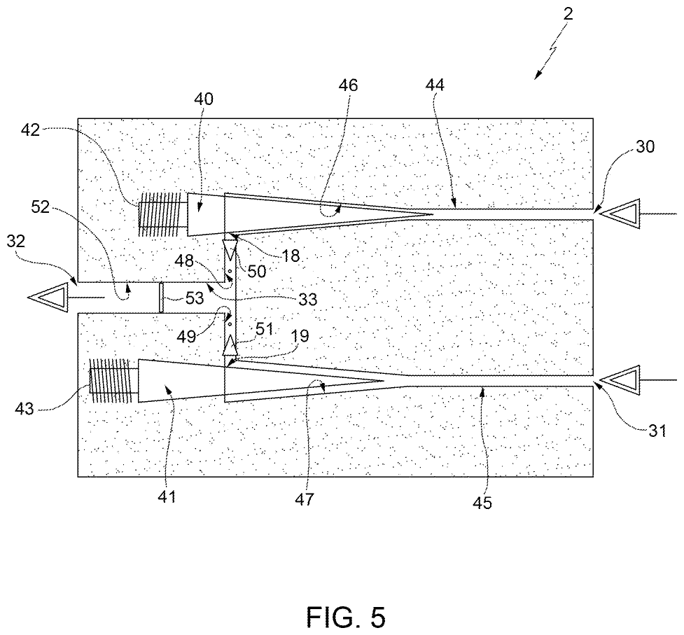

More precisely, the valve 2 comprises (FIG. 5):
a duct 44 open at one of its ends defined by the inlet 30 and closed at one of its ends 42 opposite to the inlet 30; and
a duct 45 open at one end defined by the inlet 31 and closed at an end 43 opposite the inlet 31.

The ducts 44, 45 are engaged by the respective regulators 40, 41 so as to define respective crossing volumes 46, 47 and, therefore, distributed hydraulic pressure losses having variable area and length according to the position of the regulators 40, 41 inside the respective ducts 44, 45.

In the case illustrated, the ducts 44, 45 and the regulators 40, 41 have respective first conical portions and second cylindrical portions. The first portion and the second portion of each regulator 40, 41 engages with clearance the first portion and the second portion respectively of the relative duct 44, 45.

The volumes 46, 47 also comprise first conical portions and second cylindrical portions.

The position of the regulators 40, 41 inside the ducts 44, 45 can be adjusted by the user, according to the quality of the beverage mixed with gas which said user wishes to dispense.

Preferably, the regulators 40, 41 are tapered, proceeding from the respective ends 42, 43 towards respective inlets 30, 31.

The volumes 46, 47 are tapered, in the same direction as the regulators 40, 41, i.e. proceeding from the ends 42, 43 towards the respective inlets 30, 31.

The ducts 44, 45 further comprise respective openings 18, 19 interposed between the respective inlets 30, 31 and the corresponding ends 42, 43.

The valve 2 further comprises:
a pair of ducts 48, 49, which are interposed between respective openings 18, 19 and the chamber 33; and
a pair of respective valves 50, 51 which are interposed along respective ducts 48, 49 to prevent return of the gas and the beverage mixed with gas respectively towards the respective openings 18, 19.

The valve 2 further comprises:
a duct 52, which extends between the chamber 33 and the outlet 32; and
a turbulence generator device 53 known as “creamer” which is interposed along the duct 52 in order to increase the degree of turbulence and mixing of the beverage mixed with gas. In this way, it is possible to mix a multitude of gas bubbles with the beverage in a stable uniform manner until the beverage mixed with the gas is dispensed.

In particular, the device 53 is a disc housed inside the duct 52 and provided with a plurality of holes crossed by the beverage in which the gas has been mixed.

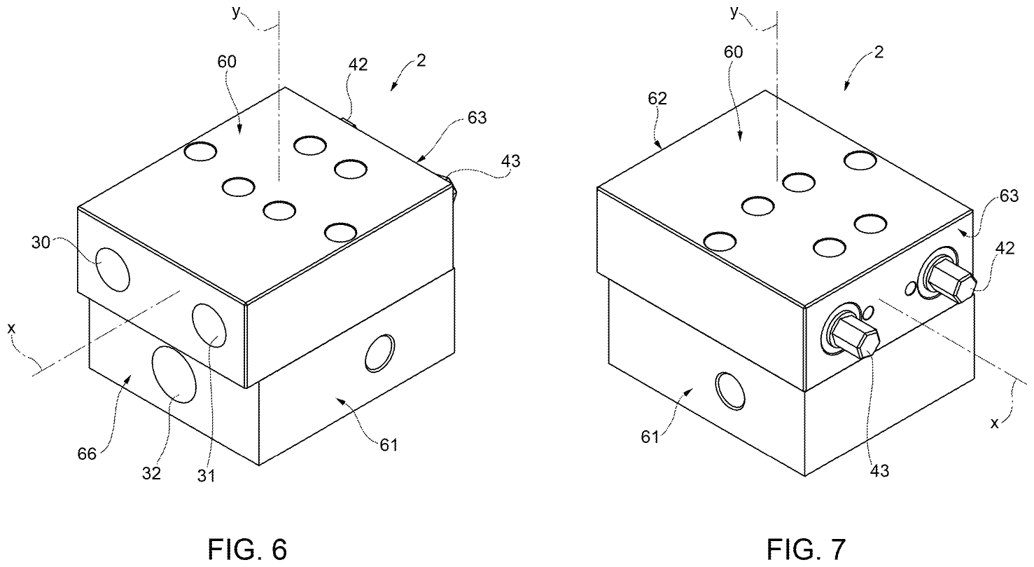

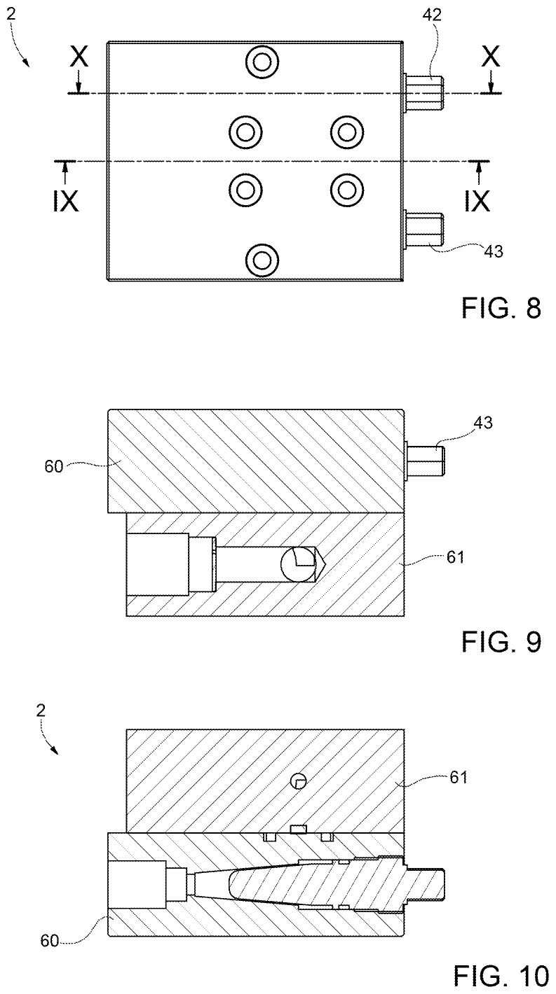

With reference to FIGS. 6 to 10, in the case illustrated, the valve 2 is formed of two bodies 60, 61 overlapped and bound to each other in a direction Y.

The body 60 arranged in use at the top defines, at respective opposite faces 62, 63 along a direction X orthogonal to the direction Y:
the inlets 30, 31 defined by the face 62;
the ends 42, 43 defined by the face 63; and
the openings 18, 19.

The body 61 arranged in use at the bottom defines, at a face 66 parallel to the face 62, 63 and arranged at the face 62, the outlet 32.

The body 61 further defines the chamber 33 and the duct 52.

The ducts 44, 45 extend partly inside the body 60 and partly inside the body 61.

In the case illustrated, the ducts 44, 45, 52 are parallel to the direction X while the duct 52 is parallel to the direction Y.

The fluidic circuit 15 comprises a pneumatic or electric pump 81 adapted to extract the beverage still to be mixed from the source 14.

Preferably, the pump 81 is operated by the gas flowing out of the source 3.

The pump 81 comprises, in particular:
a suction section 82 fluidically connected to the source 14; and
a delivery section 83 fluidically connected to the inlet 31.

The pump 81 has a characteristic such as to dispense the non-mixed beverage at the section 82 with the same pressure as the gas or compressed air of the fluidic circuit 15.

The fluidic circuit 15 further comprises:
a fluidic line 90, which extends from the source 13 of gas or compressed air under pressure as far as the pump 81 and is adapted to allow operation of the pump 81 by means of the compressed air delivered by the compressor of the source 3;
a fluidic line 91, which extends between the source 14 and the pump 81 and defines a suction line of the pump 81; and
a fluidic line 92, which extends between the pump 81 and the inlet 31 and defines a delivery line of the pump 81.

In the case illustrated, the fluidic circuit 15 also comprises:
a fluidic line 93, which forms a derivation of the fluidic line 90 arranged upstream of the pump 81 and is fluidically connected to the inlet 30;
a fluidic line 94, which forms a derivation of the fluidic line 92 and extends between a section of the fluidic line 92 interposed between the pump 81 and the valve 2, and the mouth 12 of the dispenser 10; and
a fluidic line 95, which extends from the valve 2 as far as the mouth 11.

The fluidic circuit 15 further comprises a pressure gauge 96 interposed along the fluidic line 90 and adapted to stabilize the inevitable pressure fluctuations of the gas flowing out of the source 3, if the latter is a compressor.

As regards the cooling system for cooling the beverage without gas contained in the source 14, various solutions are possible, all falling within the protective scope of the present invention.

In particular, according to a first solution (not illustrated), the cooling system is formed of a refrigerator arranged in a remote position from the source 14 and interposed between the source 14 and the valve 2. In particular, the refrigerator is crossed by a supply duct of the beverage not mixed with gas so as to cool the beverage. The refrigerator can be alternatively arranged below or above a bar counter.

According to an alternative solution (also not illustrated), the refrigerator entirely houses the source 14 and the dispenser 10 can be alternatively arranged below or above a bar counter.

The operation of the dispenser device 1 is described below with reference to the embodiment of FIG. 1, in which the source 3 is the air compressor and the source 14 is the non-pressurizable bag-in-box.

The operation of the dispenser device 1 is furthermore described starting from a condition in which:
the levers 16, 17 are in the respective open and closed configurations;
the regulators 40, 41 are arranged inside the ducts 44, 45 in respective positions defining respective crossing volumes 46, 47 for the non-mixed beverage and the gas respectively, on the basis of the desired scenic effect of the mixed beverage and the height of the froth desired when the beverage is dispensed.

The compressor forming the source 3 is operated so as to generate a flow of gas under pressure along the fluidic line 90.

Said gas flow operates the pump 81, which sucks the non-mixed beverage from the source 14 by means of the fluidic line 91 and sends it to the inlet 31 by means of the fluidic line 92.

The gas flow that flows along the fluidic line 90 furthermore reaches the inlet 30 of the valve 2 through the fluidic line 93.

Due to the conformation of the pump 81, the pressure of the gas at the inlet 30 and of the non-mixed beverage at the inlet 31 are identical in the case illustrated.

The pressure gauge 96 allows control of starting and stopping of the compressor forming the source 3 within a given pressure range, despite the inevitable increase in the delivery pressure of the compressor forming the source 13.

Due to the fact that the mouth 11 is at atmospheric pressure following operation of the lever 16, a first pressure drop is generated between the inlet 30 and the chamber 33 for the gas, and a second pressure drop between the inlet mouth 31 and the chamber 33 for the non-mixed beverage.

Furthermore, the regulators 40, 41 determine, according to their position within the respective ducts 44, 45:
a first pressure loss acting on the gas between the inlet 30 and the chamber 33; and
a second pressure loss acting on the non-mixed beverage between the inlet 31 and the chamber 33.

Consequently, the regulators 40, 41 control the first gas flow and the second beverage flow rate to be charged between the respective inlets 30, 31 and the chamber 33.

The membranes 50, 51 prevent the return of the beverage with the mixed gas from the chamber 33 towards the inlets 30, 31.

Inside the chamber 33, the first gas flow rate and the second beverage flow rate to be charged are mixed together in a uniform manner forming the mixed beverage.

Subsequently, the mixed beverage flows from the chamber 33 towards the mouth 11 through the device 53, the outlet 33 and the fluidic line 95 as far as the mouth 11.

The device 53 increases the degree of turbulence of the mixed beverage. More precisely, the device 53 creates a multitude of gas bubbles, which are maintained in the mixed beverage in a stable uniform manner until the beverage is dispensed.

Once dispensing of the beverage mixed with gas has been completed, the user re-sets the lever 16 to the closed configuration.

To vary the scenic effect and the height of the froth of the mixed beverage dispensed, the user will vary the position of one or both the regulators 40, 41, thus varying the pressure losses within the ducts 44, 45 and the value of the first and second flow of gas and beverage mixed with the gas.

To dispense only the non-mixed beverage, the user operates the lever 17 in order to move the mouth 12 to the relative open configuration.

In this way, the non-mixed beverage flows from the fluidic line 92 along the fluidic line 94 as far as the mouth 12, by-passing the valve 2.

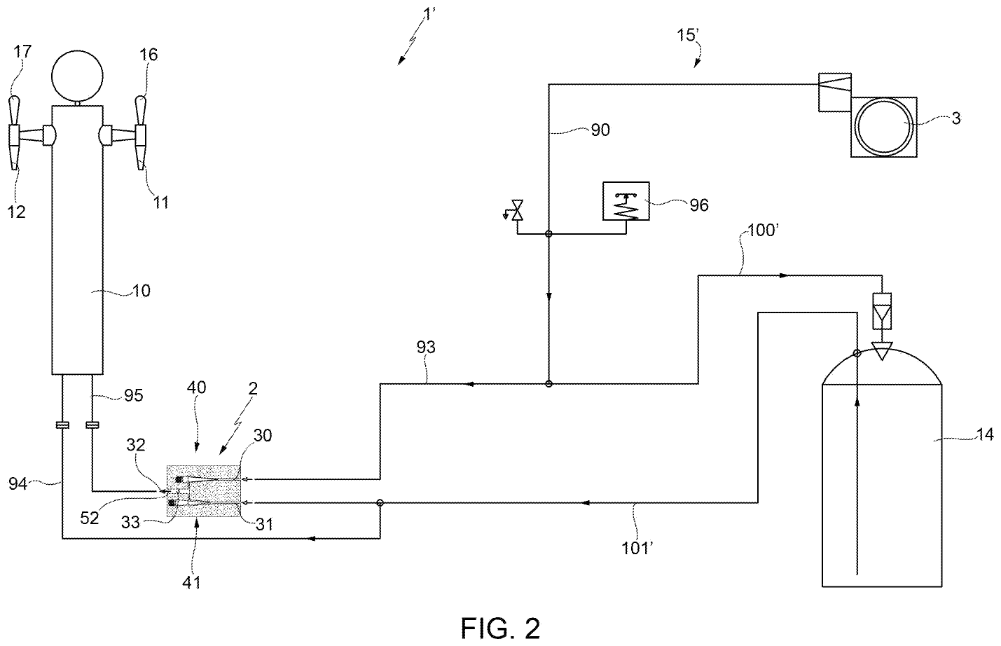

With reference to FIG. 2, the number 1′ indicates a device according to a second embodiment of the present invention.

The device 1′ is similar to the device 1 and below will be described only insofar as it differs from the latter; identical or equivalent parts of the devices 1, 1′ will be distinguished, where possible, by the same reference numbers.

In particular, the device 1′ differs from the device 1 due to the fact that the source 14 is a pressurizable keg (illustrated) or a container within which a pressurizable bag of the KEY KEG type (not illustrated) is housed, and due to the fact that it does not comprise the pump 81.

The device 1′ differs from the device 1, furthermore, due to the fact that the compressor forming the source 3 pressurizes the source 14.

In greater detail, the fluidic circuit 15′ differs from the fluidic circuit 15 due to the fact that it comprises:
a fluidic line 100′ forming a derivation of the fluidic line 90 and adapted to convey the gas under pressure into the keg forming the source 14;
a fluidic line 101′ fluidically interposed between the source 14 and the inlet 31 and adapted to convey the non-mixed beverage under pressure from the source 14 to the inlet 31 at the same pressure as the gas delivered from the source 3.

The fluidic line 94 furthermore forms a derivation of the fluidic line 101′.

The operation of the device 1′ differs from that of the device 1 due to the fact that the compressor forming the source 13 sends the gas into the keg forming the source 14 so as to push the non-mixed beverage towards the inlet 31 and along the fluidic line 101′ at the same pressure as the gas sent from the source 13 to the inlet 30.

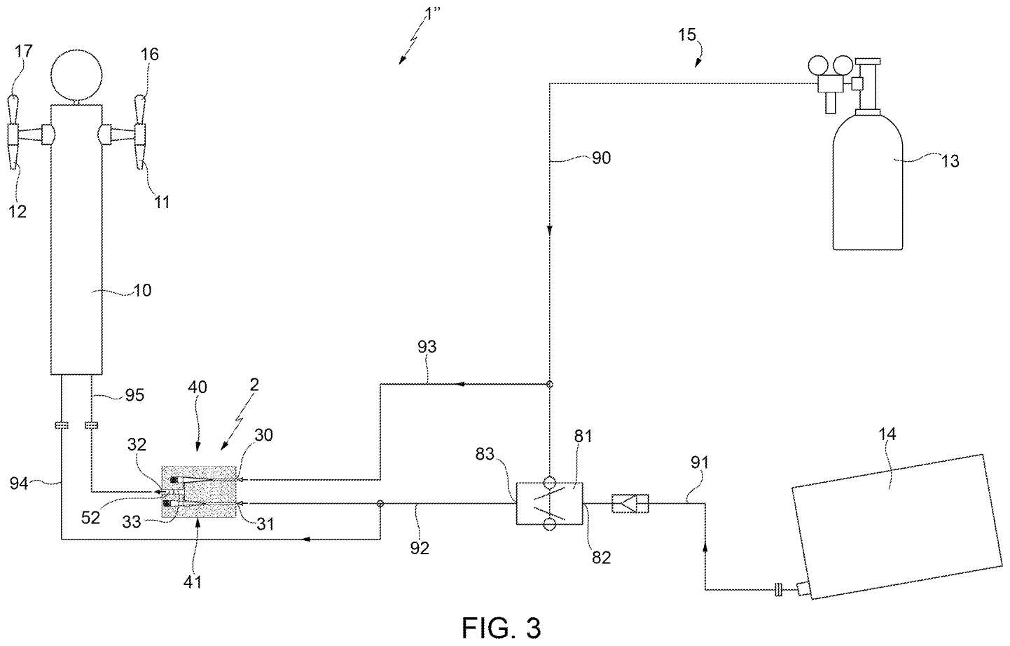

With reference to FIG. 3, the number 1″ indicates a device according to a third embodiment of the present invention.

The device 1″ is similar to the device 1 and will be described below only in the aspects that differ from the latter; identical or equivalent parts of the devices 1, 1″ will be distinguished, where possible, by the same reference numbers.

In particular, the device 1″ differs from the device 1 due to the fact that the source 13 is a bottle filled with the gas under pressure and configured to deliver the gas at a constant pressure, and due to the fact that it does not comprise the pressure gauge 96.

The operation of the device 1″ differs from that of the device 1 due to the fact that the delivery pressure of the gas from the source 13 is not limited by the pressure gauge 96, but by a pressure reducer.

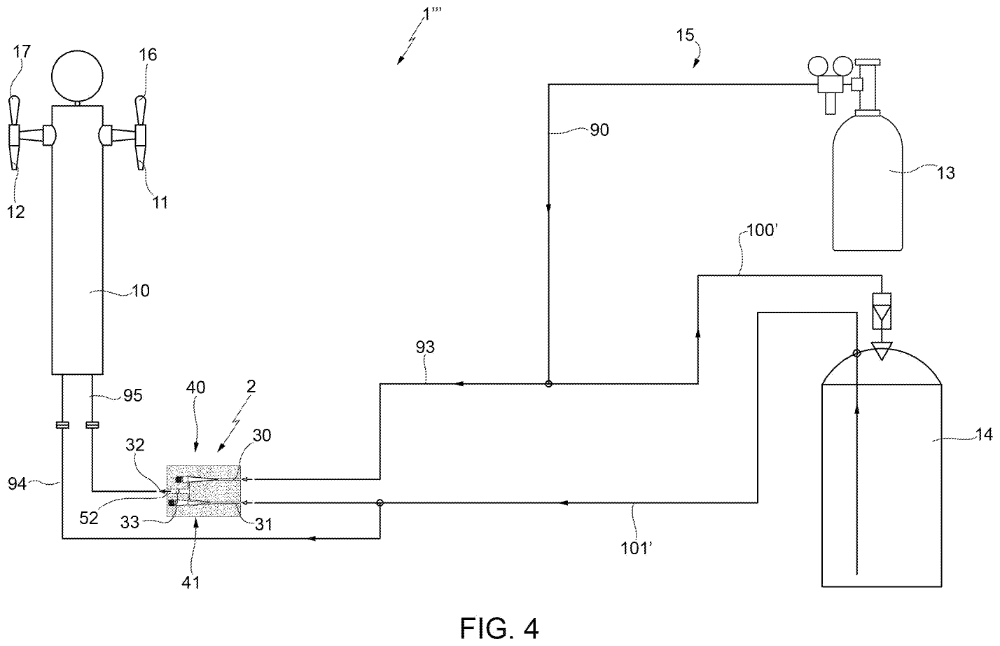

With reference to FIG. 4, the number 1′″ indicates a device according to a third embodiment of the present invention.

The device 1′″ is similar to the device 1′ and will be described below only in the aspects that differ from the latter; identical or equivalent parts of the devices 1′, 1′″ will be distinguished, where possible, by the same reference numbers.

The device 1′″ differs from the device 1′ due to the fact that the source 13 is a bottle filled with the gas and configured to deliver the gas at a constant pressure, and due to the fact that it does not comprise the pressure gauge 96.

The operation of the device 1″ differs from that of the device 1 due to the fact that the delivery pressure of the gas from the source 13 is not limited by the pressure gauge 96.

From an examination of the valve 2 and retro-fitting method and delivery method according to the present invention, the advantages it offers are evident.

In greater detail, when the lever 16 is arranged in the open configuration and therefore the mouth 11 allows the passage of the beverage mixed with the gas, the regulators 40, 41 allow the passage of a first flow of gas between the inlet 30 and the chamber 33 and a second flow of non-mixed beverage between the inlet 31 and the chamber 33.

The mixing of said first and second flow allows the gas to be charged in the beverage not yet mixed, thus forming the beverage mixed with the gas.

It is important to underline that the gas is mixed into the not-yet-mixed beverage only when delivery of the beverage mixed with the gas is requested. In fact, when the lever 16 is arranged in the closed configuration, there is substantially no passage of gas or non-mixed beverage through the valve 2.

Consequently, in the case of a casual drink, i.e. a beverage delivered at intervals of a few hours, the mouth 11 delivers the beverage mixed with the gas substantially as soon as the lever 16 has been set to the open configuration.

In short, with respect to the known solutions previously described, the present invention minimizes the number of dispensing operations that are expected and substantially eliminates the quantity of beverage that has to be thrown away before obtaining the expected scenic effect of the mixed beverage dispensed.

In addition, the valve 2 allows the user to adjust the height of the froth of the beverage mixed with gas dispensed by simply adjusting the position of the regulators 40, 41 inside the ducts 44, 45.

The membranes 50, 51 prevent return of the gas and non-mixed beverage from the chamber 33 to the inlets 30, 31 respectively.

The device 53, also known as creamer, increases the degree of turbulence of the beverage mixed with gas between the chamber 33 and the outlet 32. In this way, it is possible to maintain a multitude of gas bubbles mixed in a stable and uniform manner within the beverage until the moment when it is dispensed at the mouth 11.

Preferably, the pressure of the gas at the inlet 30 is substantially the same as the non-mixed beverage at the inlet 31.

This prevents the gas or the non-mixed beverage from flowing through the respective ducts 44, 45 when the lever 16 is moved from the open to the closed configuration. Furthermore, said pressure equivalence does not require the use of further regulators, in addition to the one downstream of the bottle forming the source 13, considerably simplifying construction and maintenance of the device 1.

Said pressure equivalence is obtained:
by selecting the pump 81 so that the pressure at the delivery section 83 coincides with the pressure of the gas flowing out of the source 13 and operating the pump 81, if the source 14 is a non-pressurizable container, for example a bag-in-box;
by fluidically connecting the source 13 of gas under pressure to the source 14, if the latter is a keg or a KEY KEG type container.

Due to the above, the device 10 uses the gas contained in the source 13 as a propellant to push the non-mixed beverage from the source 14 towards the inlet 31.

If the source 13 is a compressor, the pressure gauge 96 allows starting and stopping of the compressor forming the source 3 within a given pressure range, despite the inevitable increase in delivery pressure of the compressor forming the source 13.

Lastly, the valve 2 can be easily retro-fitted to an existing dispenser device provided with the sources 13, 14. For said purpose, it is sufficient to fluidically connect the inlets 30, 31 to the sources 13, 14 respectively and the outlet 32 to the mouth 11.

Lastly, it is clear that modifications and variations can be made to the valve 2, to the retro-fitting method and to the dispensing method described and illustrated here that do not depart from the protective scope defined by the claims.

In particular, the valve 2 could comprise one single compensator.

Furthermore, when the lever 16 is in the open configuration, the pressure values at the inlets 30, 31 could be different from each other.

1. A mixing valve (2) for a dispensing device (1) for dispensing a cooled beverage mixed with a gas, in particular nitrogen or a mixture containing nitrogen, comprising:
a first inlet (30) which can be fluidically connected to a first source (13) of said gas at a pressure greater than the atmospheric pressure and adapted, in use, to be supplied with said gas;
a second inlet (31) which can be fluidically connected to a second source (14) of said beverage without gas and adapted, in use, to be supplied with said beverage not mixed with said gas;
an outlet (32) which can be fluidically connected to a first dispensing mouth (11) for dispensing said beverage mixed with said gas; said dispensing mouth (11) being, in use, selectively available in a closed or open configuration to prevent or allow respectively the dispensing of said cooled beverage mixed with said gas;
a mixing chamber (33) interposed between said first and second inlet (30, 31) on one side and said outlet (32) on the other side and adapted to allow mixing of said gas and beverage not mixed with said gas, thus forming said beverage mixed with said gas; and
regulation means (40, 41), configured to allow, when said first dispensing mouth (11) is arranged in said open configuration, the passage, respectively, of a first flow rate value of said gas between said first inlet (30) and outlet (32) and a second flow rate value of said non-mixed beverage between said second inlet (31) and outlet (32).

2. The valve according to claim 1, comprising:
a first duct (44) interposed between said first inlet (30) and said chamber (33) and defining a first section (46) for the passage of said gas; and
a second duct (45) interposed between said second inlet (31) and said chamber (33), and defining a second section (47) for the passage of said beverage without gas;
said regulation means (40, 41) comprising, in turn:
a first shutter (40) housed in an adjustable manner inside said first duct (44) so as to selectively regulate said first flow rate value of said gas which flows, in use, between said first inlet (30) and said outlet (32); and/or
a second shutter (41) housed in an adjustable manner inside said second duct (45) so as to selectively regulate said second flow rate value of said non-mixed beverage which flows, in use, between said second inlet (31) and said outlet (32).

3. The valve according to claim 2, wherein at least one of said first and second shutters (40, 41) can be moved inside the relative first or second duct (44, 45) thus varying the fluid resistance encountered, in use, by said gas and non-mixed beverage respectively and consequently regulating said first and second flow rate values.

4. The valve according to claim 2, wherein at least one of said first or second shutter (40, 41) has, at least partly, a conical conformation and the relative first or second duct (44, 45) also has an at least partly conical conformation; and/or comprising:
a first non-return fluidic element (50), which is interposed between said first inlet (30) and said mixing chamber (33), in order to prevent a return flow of said beverage without gas from said mixing chamber (33) to said first inlet (30); and/or
a second non-return fluidic element (51), which is interposed between said second inlet (31) and said mixing chamber (33), in order to prevent a return flow of said gas from said mixing chamber (33) to said second inlet (31).

5. The mixing valve according to claim 1, comprising a turbulence generator device (53), which is interposed between said chamber (33) and said outlet (31).

6. The valve according to claim 1, wherein a first pressure value of said gas at said first inlet (30) is, in use, equal to a second pressure value of said non-mixed beverage at said second inlet (31).

7. A dispensing device (1) for dispensing a cooled beverage mixed with a gas, in particular nitrogen or a gas containing nitrogen, comprising:
said first source (13) of said gas at said pressure greater than the atmospheric pressure;
said second source (14) of said non-mixed beverage;
said dispensing mouth (11); and
a valve (2) according to claim 1.

8. The device according to claim 1, wherein said second source (14) of said beverage without said gas is a non-pressurizable container, in particular a bag-in-box;
said device (1) being furthermore characterized in that it comprises a pump (81) comprising, in turn, a suction section (82) fluidically connected to said non-pressurizable container and a delivery section (83) fluidically connected to said first and second inlet (30, 31);
said pump (81) being operated by the gas flowing out of said first source (13) of said gas;
said pump (81) being configured to send to said delivery section (83) said non-mixed beverage at the same pressure as said gas operating the pump (81).

9. The device according to claim 7, wherein said first source (13) is a compressor and in that it comprises a pressure gauge (96) interposed along a fluidic line (90) extending between said first source (13) and said pump (81).

10. The device according to claim 1, wherein said second source (14) of said beverage without said gas is a pressurizable container, and in that said first source (13) can be fluidically connected to said second source (14) to pressurize said beverage, and in that said second source (14) can be fluidically connected in a direct manner to said second inlet (31) of said valve (2).

11. The dispensing device according to claim 7, comprising:
a further dispensing mouth (12), which is adapted to dispense said beverage without said gas; and
a further fluidic line (94), which fluidically connects said second source (14) and said second dispensing mouth (12) by-passing said mixing valve (2).

12. A retro-fitting method of a dispensing device (1) for dispensing a cooled beverage mixed with a gas, in particular nitrogen or a mixture containing nitrogen; said dispensing device (1) comprising:
a first source (13) of said gas at a pressure greater than the atmospheric pressure;
a second source (14) of said non-mixed beverage; and
a dispensing mouth (11), which is selectively available in a closed or open configuration respectively to prevent or allow the dispensing of said cooled beverage mixed with said gas;
characterized in that it comprises the steps of:
i) fluidically connecting a first inlet (30) of a mixing valve (2) to said first source (13);
ii) fluidically connecting a second inlet (31) of said valve (2) to said second source (14);
iii) fluidically connecting a first outlet (32) of said valve (2) to said dispensing mouth (11); and
iv) interposing a mixing chamber (33) between said first and second inlet (30, 31) on one side and said outlet (32) on the other side;
v) arranging regulation means (40, 41) between said first and second inlet (30, 31) on one side and at said outlet (32) on the other side; and
vi) configuring said regulation means (40, 41) to allow, when the dispensing mouth (11) is arranged in the open configuration and on the basis of the desired scenic effect of the beverage mixed with gas, the passage, respectively, of a first flow rate value of said gas between said first inlet (30) and outlet (32), and of a second flow rate value of said non-mixed beverage between said second inlet (31) and outlet (32).

13. A method according to claim 12, wherein said second source (14) is a non-pressurizable container, comprising the further steps of:
v) interposing a pump (81) between said second source (14) and said first inlet (30);
vi) operating said pump (81) by means of said gas flowing out of said second source (13); and
viii) connecting a suction section (82) of said pump (81) to said second source (14) and a delivery section (83) to said second inlet (31), in order to transfer said beverage without gas from said second source (14) to said second inlet (31).

14. The dispensing method for dispensing a cooled beverage mixed with a gas, in particular nitrogen or a mixture containing nitrogen, comprising the steps of:
i) fluidically connecting a dispensing device (1) to a first source (13) of said gas at a pressure greater than the atmospheric pressure and to a second source (14) of said non-mixed beverage; and
ii) in the case of dispensing of said beverage mixed with said gas, moving said dispensing device (1) from a closed configuration, in which it prevents the dispensing of said beverage to the outside of said dispensing device (1), to an open configuration in which it allows said dispensing;
characterized in that it comprises the steps of:
iii) fluidically connecting a first inlet (31) and a second inlet (32) of a mixing valve (2) to said first source (13) and to said second source (14) respectively;
iv) fluidically connecting a mixing chamber (33) of said valve (2) on one side to an outlet (32) of said valve (2) fluidically connected to said dispensing mouth (11) and on the other side to said first and second inlet (31, 32); and
v) allowing, when the dispensing mouth (11) is arranged in the open configuration, the passage, respectively, of a first flow rate value of said gas between said first inlet (30) and outlet (32) and of a second flow rate value of said non-mixed beverage between said second inlet (31) and outlet (32), on the basis of the desired scenic effect of the beverage mixed with gas.

15. The method according to claim 14, comprising the step vi) of using the pressure of said gas flowing out of said first source (13) to determine the feeding of said non-mixed beverage from said second source (14) to said second inlet (31).
